(19) United States
(12) Patent Application Publication
(10) Pub. No.: US 2006/0149940 A1
(43) Pub. Date: Jul. 6, 2006

(54) Implementation to save and restore processor registers on a context switch

(75) Inventor: Shubhendu S. Mukherjee, Framingham, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/024,358

(22) Filed: Dec. 27, 2004

(51) Int. Cl. G06F 9/44

(52) U.S. Cl. 712/228

(57) ABSTRACT

A method and apparatus for enabling a processor to perform a save and restore on a context switch incrementally and on demand. In one embodiment, when OS switches to a new process, the processor saves only those registers that have been modified in the current process. The processor may not bring in these registers for the new process, rather, the processor will load them on demand. If instructions from the new process do not locate their source operand in the register file, it will initiate a miss handling flow for the register and restore the register value in the register file. Then the pipeline will reissue the instruction that missed in the register file.

### BACKGROUND INFORMATION

Modern instruction set architectures favor large architectural register files to allow programmers and compilers to effectively schedule code and expose instruction-level parallelism, thereby providing high performance. Unfortunately, such large register files hinder microprocessor implementation. A large register file could require multiple pipestages or cycles to access the register file, particularly in processors with very high frequency, such as 5 GHz or more.

Additionally, a large register file may also hinder a fast context switch time. Usually, larger the amount of process-visible architectural state, greater is the time taken to save and restore this state when the operating system (OS) switches the processor between multiple processes. Modern microprocessors may support the frequent switching of execution from one portion of software to another. These portions of software may be called in various embodiments, tasks, modules, subroutines, or processes. For the present disclosure the term “processes” will be used, with the understanding that the other terms tasks, modules, or subroutines may also be comprehended by the term processes.

Fast context switch may be particularly critical for virtual machines in which user-level instructions can quite frequently trap into the operating system and/or switch to other processes, such as the virtual machine monitor and execute only a few instructions before switching to a new process. In multiprocessor or multithreaded environments, the overhead from saving and restoring a large register file will become a major issue and thus costly as a result.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a block diagram of a processor supporting a save and restore of registers on a context switch, according to one embodiment.

FIG. 2 is a flow diagram of one method of a read operation supporting a save and restore of registers on a context switch, according to one embodiment.

FIG. 3 is a flow diagram of a pseudo load after a miss signal supporting a save and restore of registers on a context switch, according to one embodiment.

FIG. 4 is a flow diagram of a reissue of a register supporting a save and restore of registers on a context switch, according to one embodiment.

FIGS. 5 is a flow diagram of a write operation supporting a save and restore of registers on a context switch, according to one embodiment.

FIG. 6 is a block diagram of a system that may provide an environment for multithreaded processors supporting a save and restore of registers, according to one embodiment.

FIG. 7 is a block diagram of an alternative system that may provide an environment for multithreaded processors supporting a save and restore of registers, according to one embodiment.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

In modern microprocessors, to switch a first process running on a processor, the OS must save the state of the first process, known as the context, and restore the context of a second process that the OS switches the processor to. When a second process replaces a first process as the process currently executing, the state of the registers for the first process needs to be saved in order to support the eventual return of the first process to the status of currently executing function.

The context consists of a variety of process-related variables, including the architectural register file, visible to the process. Instead of letting the OS save and restore the register file on a context switch, the present implementation enables the processor to do the save and restore incrementally and on demand. This implementation will be known as a “lazy save and restore” (LSR) for the purposes of this disclosure.

At an abstract level, LSR maps the architectural register file to a user-visible portion of the address space in memory. This enables the OS to allocate as many contexts as the number of address spaces it may allocate. When the OS switches to a second process, the processor saves only the registers that have been modified in the current quantum for that process. A quantum may be the period of execution of a process between two context switches. However, the processor will not bring in the registers for the second process that the OS is switching to. Instead, the processor will load them on demand, one at a time or in multiples. When instructions from the second process do not locate their source register operands in the register file or anywhere in the pipeline, then it will initiate a miss handling flow for the register and restore the register value in the architectural register file. Then, the pipeline will reissue this instruction that missed in the register file.

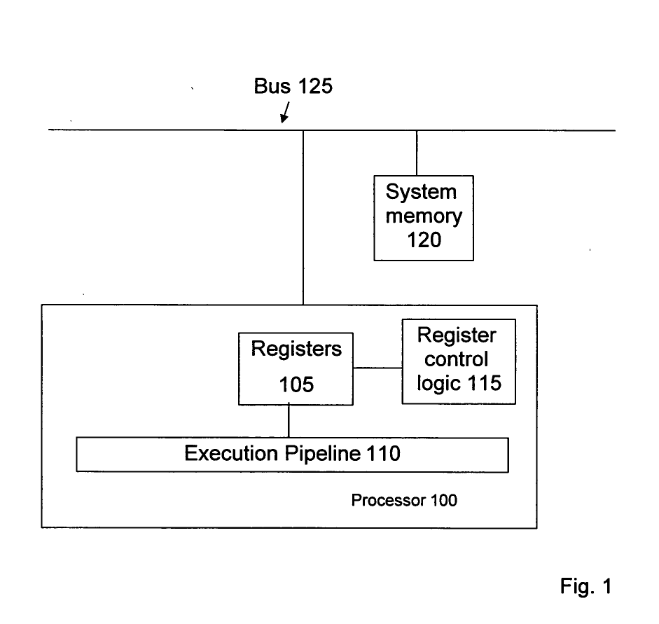

Referring now to FIG. 1, a block diagram of a processor 100 supporting LSR is shown, according to one embodiment. The registers 105 may be used as source or destination registers for the execution pipeline 110 under the control of the register control logic 115. In one embodiment, registers 105 may be the Itanium™ system registers utilized with Itanium™ class microprocessors manufactured by Intel® Corporation. The Itanium instruction set architecture provides 128 integer and floating point registers, 64 1-bit predicate registers, and several other miscellaneous registers.

Typically, modern microprocessors have a bypass network near the execution units which temporarily stores register values for a few cycles after they are produced in the execution units. Register values produced by the execution units may be fed back to the execution units bypassing the architectural register file, thus creating a bypass network.

When a first process is replaced as the current process by a second process, such as when the first process calls the second process, the register control logic 115 may initiate the saving of the contents of some or all of the registers into memory 120. In one embodiment, the register control logic 115 may determine a subset of registers from the set of registers 105 which were actually read from or written to by commands within the first process prior to calling the second process. Then register control logic 115 may store the contents of the subset of registers into a portion of memory 120 allocated, along with recording any information required to restore the registers 105 for subsequent use by the first process.

In one embodiment, LSR augments each register in the register file with the following bits: a valid bit, poison bit and a modify bit. The register control logic 115 records the status of these bits for subsequent use of the registers by other processes. The valid bit indicates if the register in the register file is valid; the poison bit indicates if the instruction reading the register needs to be reissued and the modified bit indicates if a register has been written since the last context switch.

Poisoning is a common mechanism used in most modern microprocessors to allow speculative issue of load instructions. An instruction dependent on the result of the load may be issued before the result of the load's hit or miss in the data cache is known. If the load instruction poisons the register value that the dependent instruction needs, then this dependent instruction can be squashed and reissued after the load value returns. This may be optimizes for the case when loads hit in the data cache, thereby improving performance. The LSR implementation may use the same poison bits to replay instructions whose source operands are missing from the architectural register file and the bypass network.

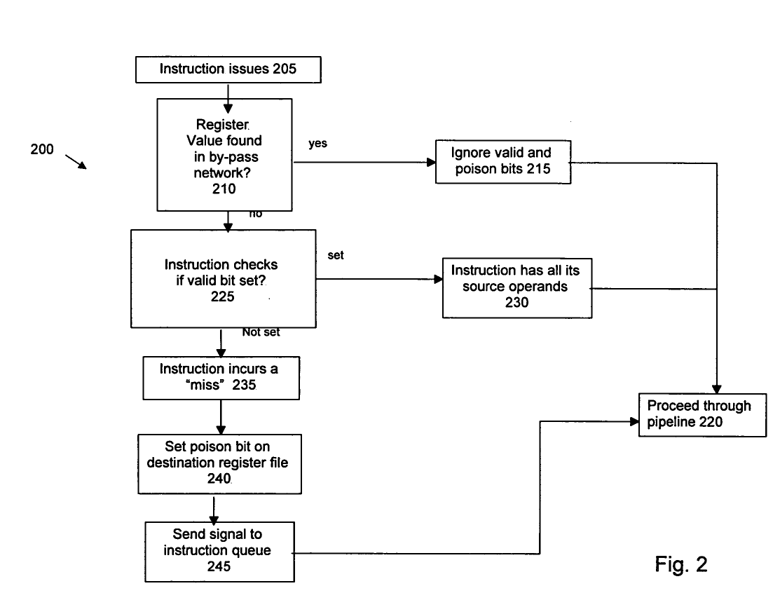

Referring to FIG. 2, a flow diagram 200 of a read operation is shown supporting LSR, according to one embodiment. When an instruction is issued 205, the instruction accesses the register file to read its source operand registers. Upon accessing the register file, the instruction reads the source registers as well as the corresponding valid and poison bits stored therein and carries them forward along the pipeline.

When the instruction reaches the execution unit in the pipeline, it checks the bypass network 210 to see if its source register operands are available in the bypass network. If they are available in the by-pass network, then the instruction ignores the valid and poison bits read from the architectural register file 215. The instruction then reads the register and proceeds with the regular computation through the pipeline 220.

If one or more of the register values are not available in the bypass network, then the instruction checks the valid and poison bits 225. If the valid bits for these source operands are set and the poison bits are not set, then the instruction has all its source operands 230 and, therefore, can proceed down the pipeline 220. This enables the instruction to know that for a particular register value, if the valid bit was set, then the register file is valid and if the poison bit was not set, then the register does not need to be reissued.

If at least one of the source registers is not available in the bypass network and does not have its valid bit set, then the instruction incurs a “miss” for that source operand register 235. The pipeline control will still allow the instruction to proceed down the pipeline 220, however, the pipeline control will first mark its destination register file as poisoned (thereby setting the poison bit) 240 and secondly send a signal to the instruction queue 245, so that the instruction queue can start the miss flow for the register.

Accordingly, when the instruction with an unavailable source register commits, it marks its destination register with the poison bit set. The set poison bit will be carried through the bypass network into the architectural register file. Thus, any instruction reading a register with its poison bit set will know that it obtained incorrect values and, therefore, must be reissued. This poison bit mechanism helps replay dependent chains of instructions. An instruction with its source operands marked as poisoned must also mark its destination register as poisoned to allow the replay to work correctly. However, if the register value in the bypass network is not poisoned, but the value in the architectural register file is, then the instruction can still proceed down the pipeline without a replay because the bypass network contains the most recent update to this register value.

Assuming, for example, an ADD instruction issues and its unable to write the destination register. One reason maybe it has an invalid bit (valid bit=0) in one of its source operands and may not read it, and thus cannot produce a destination register. In this example, the OS may either stall in the pipeline or it may go ahead and mark the destination register of the ADD instruction by setting its poison bit (poison bit=1). If a subsequent register, that depends on this ADD instruction, issues, it will know that the destination register is poisoned. Then OS will know its reading a poison register and the register has to be reissued from the instruction queue.

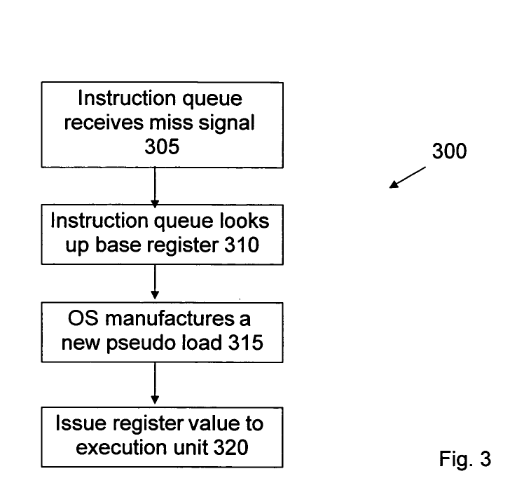

Referring to FIG. 3, a flow chart 300 of obtaining a pseudo load, according to one embodiment. Upon the instruction queue receiving the miss signal for an instruction's source register 305 the pipeline control looks up a new architectural register 310. This architectural register may contain the base virtual address where the registers of the processors will be mapped to. This new architectural register will be known as the “LSR base register” for purposes of this disclosure.

The OS is responsible for setting the LSR base register as well as saving and restoring it on every context switch. This is the only register that the OS must save and restore with LSR. Using the address in this register and register specifier, the OS now keeps this instruction, manufactures a new pseudo load 315 to load the register value from the address space, and then issues it to the execution unit 320.

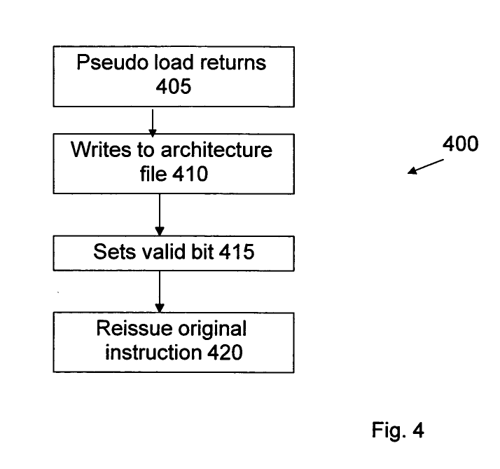

FIG. 4 refers to a flow chart 400 of a reissue of a register, according to one embodiment. When this load returns 405, it writes the architectural register file with the register value 410 and sets the valid bit 415. Then, the pipeline control may restore the pipeline's original operation by re-issuing the original instruction that missed in the register file 420.

Alternatively, the operation of the pseudo load 400 may be optimized. The instruction queue may create a fake dependence from the pseudo load to the instruction that missed in the register file. By creating a fake dependence, the missing instruction can be issued speculatively to the execution units. If the load can return the value to the bypass network, then this instruction can pick up the new value from the bypass network and proceed.

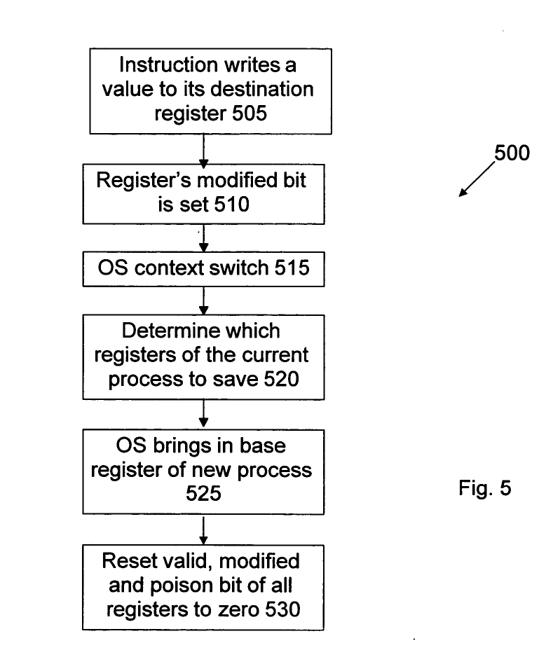

Referring now FIG. 5 a flow chart 500 of an instruction writing to its destination register supporting LSR, according to one embodiment. Any time an instruction writes a value to its destination register 505, the LSR implementation sets that register's modified bit 510. When a context switch occurs 515, the processor may use these modified bits to decide which registers of the process being switched to save 520 in the back-up address space or memory location. On the context switch, OS brings in the LSR base register of the new process 525, resets the valid, modified, and poison of all the registers to zero 530 (i.e., invalid state).

Alternatively, a processor may issue writes to part of the 64-bit register. If the processor does a partial write to a destination register, OS may treat the destination register in the same way as the source operand and read it first. If the processor writes a minimum of one byte, the OS may have one modified bit per byte (8 bits) of each register. Then, a processor may write the specific bits of a destination register without having to read the entire register first. However, when a processor saves registers with multiple modified bits per register, then it has to be careful to ensure only the modified bits are written back to the backup portion of the register file.

Advantageously, the LSR implementation reduces the restore time by restoring on demand only the source register values that are truly needed. Values not needed, such as values produced by dynamically dead instructions, will not be restored by the processor. In addition, values created and read during a quantum need not be restored from the backup register file either. This can result in substantial savings in overall context switch time, particularly for contexts that execute few instructions before switching to a different process. Many standard OS calls have this characteristic as well as virtual machines, which are becoming increasingly critical to the computer industry.

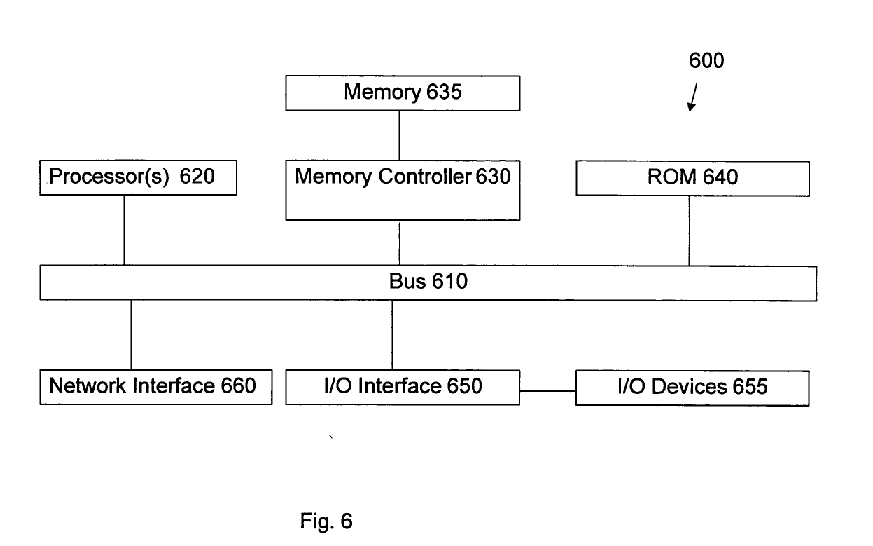

FIG. 6 is a block diagram of a system that can provide an environment for multithreaded processors supporting a lazy save and restore of registers. The system illustrated in FIG. 6 is intended to represent a range of systems. Alternative systems may include more, fewer and/or different components.

System 600 includes bus 610 or other communication device to communicate information, and processor(s) 620 coupled to bus 610 to process information. In one embodiment, system bus 610 may be the Itanium™ system bus utilized with Itanium™ class microprocessors manufactured by Intel® Corporation. System 600 further includes random access memory (RAM) or other dynamic memory as well as static memory, for example, a hard disk or other storage device 635 (referred to as memory), couple to bus 610 via memory controller 630 to store information and instructions to be executed by processor(s) 620. Memory 635 also can be used to store temporary variables or other intermediate information during execution of instructions by processor(s) 620. Memory controller 630 can include one or more components to control one or more types of memory and/or associated memory devices. System 600 also includes read only memory (ROM) and/or other static storage device 640 coupled to bus 610 to store static information and instructions for processor(s) 620.

System 600 can also be coupled via a bus 610 to input/output (I/O) interface 650. I/O interface 650 provides an interface to I/O devices 655, which can include, for example, a cathode ray tube (CRT) or liquid crystal display (LCD), to display information to a computer user, an alphanumeric input device including alphanumeric and other keys and/or a cursor control device, such as a mouse, a trackball, or cursor direction keys. System 600 further includes network interface 660 to provide access to a network, such as a local area network, whether wired or wireless.

Instructions are provided to memory 635 from a storage device, such as magnetic disk, a read-only memory (ROM) integrated circuit, CD_ROM, DVD, via a remote connection (e.g., over a network via network interface 860) that is either wired or wireless, etc.

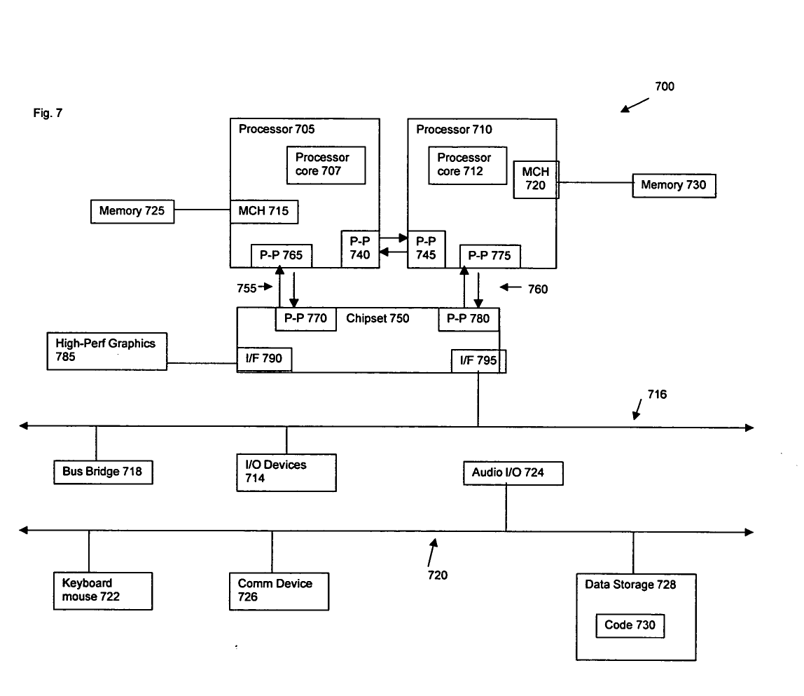

Referring now to FIG. 7, the system 700 includes processors supporting a lazy save and restore of registers. The system 700 generally shows a system where processors, memory, and input/output devices are interconnected by a number of point-to-point interfaces. The system 700 may also include several processors, of which only two, processors 705, 710 are shown for clarity. Each processor 705, 710 may each include a processor core 707, 712, respectively. Processors 705, 710 may each include a local memory controller hub (MCH) 715, 720 to connect with memory 725, 730. Processors 705, 710 may exchange data via a point-to-point interface 735 using point-to-point interface circuits 740, 745. Processors 705, 710 may each exchange data with a chipset 750 via individual point-to-point interfaces 755, 760 using point to point interface circuits 765, 770, 775, 780. Chipset 750 may also exchange data with a high-performance graphics circuit 785 via a high-performance graphics interface 790.

The chipset 750 may exchange data with a bus 716 via a bus interface 795. In either system, there may be various input/output I/O devices 714 on the bus 716, including in some embodiments low performance graphics controllers, video controllers, and networking controllers. Another bus bridge 718 may in some embodiments be used to permit data exchanges between bus 716 and bus 720. Bus 720 may in some embodiments be a small computer system interface (SCSI) bus, an integrated drive electronics (IDE) bus, or a universal serial bus (USB) bus. Additional I/O devices may be connected with bus 720. These may include keyboard and cursor control devices 722, including mouse, audio I/O 724, communications devices 726, including modems and network interfaces, and data storage devices 728. Software code 730 may be stored on data storage device 728. In some embodiments, data storage device 728 may be a fixed magnetic disk, a floppy disk drive, an optical disk drive, a magneto-optical disk drive, a magnetic tape, or non-volatile memory including flash memory.

Throughout the specification, the term, “instruction” is used generally to refer to instructions, macro-instructions, instruction bundles or any of a number of other mechanisms used to encode processor operations.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

What is claimed is:

1. A processor comprising:
a first set of registers allocated to a first process;
a circuit to selectively store contents of a first subset of the first set of registers to a memory upon making current a second process, wherein the stored contents of the first subset of the first set of registers are modified registers during the first process.

2. The processor of claim 1 wherein the circuit loads a second subset of the first set of registers for the second process, where the second subset of the first set of registers are non-modified registers during the first process.

3. The processor of claim 2 wherein the circuit initiates a miss signal when the second process requests the modified registers of the first process.

4. The processor of claim 3 wherein the circuits loads the modified registers to a register file upon receiving the miss signal.

5. The processor of claim 1 wherein each register in the first set of registers includes a valid bit, a poison bit and a modify bit.

6. The processor of claim 5 wherein the valid bit indicates if the register in a register file is valid.

7. The processor of claim 5 wherein the poison bit indicates if the register is to be reissued.

8. The processor of claim 5 wherein the modify bit indicates if the register has been written to in the first process.

9. A method comprising:
allocating a first set of registers for a first process;
storing content of a first subset of the first set of registers;
switching to a second process;
requesting the content of the first subset of the first set of registers by the second process; and
reading content of the first subset of the first set of registers upon request by the second process.

10. The method of claim 9 wherein said storing includes saving valid, poison and modify bits stored therein.

11. The method of claim 10 wherein said requesting includes determining if valid bit is set for the requested registers.

12. The method of claim 11 wherein said determining includes incurring a miss if valid bit is not set and setting the poison bit.

13. The method of claim 12 wherein said incurring includes sending a signal to an instruction queue to indicate a miss flow for the register.

14. The method of claim 13 wherein said sending includes finding new architectural register for the register incurring a miss.

15. The method of claim 14 wherein said sending includes issuing the new register value to an execution unit.

16. The method of claim 15 wherein said issuing includes writing the new register value to the architectural register and setting the valid bit.

17. The method of claim 16 wherein said setting the valid bit includes reissuing the requested register.

18. A system comprising:
A processor including a first set of registers allocated to a first process, and a circuit to selectively store contents of a first subset of the first set of registers to a memory upon making current a second process, wherein the stored contents of the first subset of the first set of registers are modified registers during the first process;
an interconnect to couple the processor to input/output devices; and
an audio input/output device coupled to the interconnect and to the processor.

19. The system of claim 18 wherein the circuit loads a second subset of the first set of registers for the second process, where the second subset of the first set of registers are non-modified registers during the first process.

20. The system of claim 19 wherein the circuit initiates a miss signal when the second process requests the modified registers of the first process.

21. The system of claim 20 wherein the circuits loads the modified registers to a register file upon receiving the miss signal.

22. The system of claim 21 wherein each register in the first set of registers includes a valid bit, a poison bit and a modify bit.

23. The system of claim 22 wherein the interconnect is a point to point interconnect.
